(19) United States
(12) Patent Application Publication
(10) Pub. No.: US 2005/0206890 A1
(43) Pub. Date: Sep. 22, 2005

(54) Method and device to ascertain physical characteristics of porous media

(75) Inventors: Andrew Hurst, Petroleum (GB); Valerie Grandjean, Petroleum, Aberdeen (GB); Alexander Kovalchuk, Aberdeen (GB); Michael Player, Fraser (GB); John Watson, Aberdeen (GB)

Correspondence Address: NIXON PEABODY, LLP, 401 9TH STREET, NW, SUITE 900, WASHINGTON, DC, 20004-2128, US

(73) Assignee: ABERDEEN UNIVERSITY, MACHAR DRIVE (GB)

(21) Appl. No.: 10/503,063

(22) PCT Filed: Jan. 31, 2003
(86) PCT No.: PCT/GB03/00447

§ 371 Date: May 13, 2005

(30) Foreign Application Priority Data
Jan. 31, 2002 (GB) 0202266.3

(51) Int. Cl. G01N 21/00

(52) U.S. Cl. 356/239.7

(57) ABSTRACT

The present invention relates to a method and device for ascertaining characteristics relating to porosity and grain size in rock sample. Four illuminators A, B, C and D direct collimated illuminating beams to a point O at the centre of a sample 40 and have projections onto the plane of the surface of the sample 40 at points A₁, B₁, C₁, and D₁. Angles <AOA₁, <BOB₁, <COC₁, and <DOD₁ have the same value of 45°. A camera (41) located directly above the point (O) acquires four images as the illuminators are individually illuminated. A processing section receives the acquired image data on line (42) and, after filtering, a common point distribution is evaluated based on the common points in the light intensity distribution data of two pairs of images with opposite illumination directions is found (A & C, B & D). At the same time, an edge enhancing distribution is evaluated based on the opposing value points in the light intensity distribution data for the opposing directions. These two distributions are combined and after thresholding, a binarised distribution is produced which is analysed using a measuring area to establish the relative amounts of one value or the other that occur in the distribution. From this, pore size distribution, grain size distribution and porosity of the sample can be found.

The present invention relates to a method and device for ascertaining physical characteristics of porous media, and in articular to ascertaining characteristics relating to orosity, permeability and grain size distribution of a porous rock or sediment sample.

Hydrocarbon reservoirs occur beneath the earth's surface and have a structure or rock formation which is analogous to a solidified sponge. The reservoir (a rock) is made up of mineral grains, which is typically >70%, together with a void content, which is typically <30%. The mineral or rock content is made up of a distribution of interconnected particles (mineral grains). The void content is formed by a plurality of microscopic pores defined between the grains and it is this that comprises the storage space for the hydrocarbon (oil and/or natural gas). Differing reservoirs will have different sized grains, and different sized pores and inter-connectivity.

During hydrocarbon exploration and production, the discovery of a reservoir and the identification of the presence of hydrocarbons therein is clearly of prime importance. However, thereafter, it is vital to determine the volume of the void content, that is to say the amount of pores (the porosity), and the degree of inter-connectivity of the pores (the permeability).

Hydrocarbon reservoirs are therefore characterised by an assessment of the grain size distribution (GSD), the porosity and the pore size distribution. The pore size distribution approximates to 1-GSD. Hence, measurement of one provides a basis for estimation of the other.

As mentioned above, the porosity is the storage space for fluids in the reservoir. The pore/grain size distribution has a major influence on the permeability and can be considered as a measure of the rate of flow through the porous media. Both these characteristics are of fundamental importance in the characterisation of reservoir rocks.

The relationship between pores/grains and permeability (K) can be expressed in the Kozeny-Carman equation:

$$K = \frac{{ⅇ}^{3}}{5 {{S}_{v}^{2} ( 1 - ⅇ )}^{2}}$$

where Sᵥ is the specific surface exposed to a fluid per unit volume of the solid porous media, and e is the base of natural logarithms.

The Kozeny Carman equation gives insight into the dependence of permeability (K) on effective porosity (the interconnection of pores). As a first approximation, K is proportional to the first power of porosity and inversely proportional to the second power of specific surface. This equation is particularly useful as it explains why fine grained porous media with effective porosity identical to coarser grained porous media have smaller permeability: as grain size decreases, specific surface areas increases as does resistance to flow.

Current techniques to determine the aforementioned characteristics tend to fall into two categories.

In the downhole environment porosity determination involves the in-situ measurement of certain physical parameters of the rocks within the borehole by means of a tool that is drawn up the borehole on the end of a long wire (“wireline-logging”) although these estimates require calibration with porosity measurements made on recovered rock samples (core). It should be noted that it is not possible to perform direct volumetric measurements on the rock down the borehole and all of the following techniques involve the derivation of porosity data from the measurement of secondary characteristics of other rock properties.

In one technique, the velocity of sound waves through the rock is measured down the borehole. This in turn allows the density of the rocks to be determined. If certain other rock properties, notably the rock matrix type and the pore fluid type, are known or can be deduced the density can then be used to compute a porosity value.

In another technique down the borehole, neutron particles are emitted from a suitable radioactive source. They collide with rock nuclei, lose energy and are finally captured by particles in the rock formation. Of the elements commonly found in sedimentary rocks, hydrogen is the most effective at reducing the energy of the neutrons. The resultant measurement is therefore primarily a hydrogen index. Hydrogen is primarily present in the formation fluids as gas, oil or water and the hydrogen index is therefore related to porosity. This is obviously an over simplification and there are many complications caused by borehole salinity (chlorine has a large absorption rate), temperature and fluid type (oil, gas or water). In addition, the rock type must be known because certain clay minerals contain bound water within the crystal lattice.

In another technique down the borehole, high energy gamma rays are emitted and gradually lose energy as they pass through the rock formation. The rate of energy loss is an indication of electron density. Given a number of other parameters, the density of the formation rocks can then be calculated. Once again there are many complicating factors which must be compensated for, notably the presence of clay, the fluid type and the thickness and density of the mud cake on the borehole wall. Formation density data are usually used in association with neutron data.

The drawback of all these downhole techniques is that they are highly complex and involve calculations that use a variety of borehole and environmental compensation factors. They all also require prior knowledge (or an assumption) of the rock type, fluid type or both. Moreover, acoustic velocity, electron density, and neutron adsorption vary. Consequently, substantial errors in porosity estimates may arise if careful calibration with measurements on rock samples taken from reservoirs at intervals is not undertaken.

Direct porosity determination involves measuring effective porosity by determining the volume of the bulk sample and the volume of either the rock matrix or the total pore space. There are two techniques used and both require sample preparation and are therefore time consuming (and hence relatively expensive) and destructive (because the sample must be removed from the core).

In the buoyancy technique, porosity is determined by measuring both the bulk volume (rock+pore space) and matrix volume (rock only) of the sample. The bulk volume is determined by immersing the sample in mercury (non-wetting). The rock volume is then determined first by weighing in air and then with the sample saturated in a wetting liquid (toluene or chloroethene).

In the gas expansion technique, a cleaned and dried sample is placed into a sample chamber connected to an expansion chamber and both are evacuated. The valve between the chambers is closed and a known initial pressure is applied to the sample chamber. The valve is opened, the pressure allowed to equalize and then measured. Using Boyles Law, given the known volumes of the pressure chambers and the sample (from the mercury immersion method) the effective porosity can then be calculated.

Fluid injection porosimetry is a standard laboratory technique for determining the pore size distribution of porous media. Using small samples, a non-wetting fluid (usually mercury) is injected, at progressively higher pressures, until all pores are filled. Porosimetry is time consuming, expensive, samples only a tiny proportion of a reservoir (a discontinuous measurement), and is implicitly destructive.

It should also be noted that since measurement of porosity is only possible on recovered (core) samples of rock and because the recovery of the core to the earths surface changes the confining conditions of the rock sample (temperature and pressure in situ stress regime), laboratory measurements of porosity require correction to subsurface conditions.

Unfortunately, the laboratory measurements of these direct techniques are destructive, as they require sub-sampling of cores, a process that disrupts and removes material thus reducing the amount of material available for other analyses. A typical reservoir core sample will therefore have a series of breaks caused by sampling.

Equally, the process of removal of samples (core plugs) for analysis does not provide a continuous record of porosity but a series of point data which is fundamentally dissimilar to the wireline log data with which they are compared.

There is a relationship between the specific surface of samples and permeability and this has led to increasing use of analysis of pore networks as part of the reservoir characterisation process. The study of pore networks can be undertaken by optical examination of thin slices of samples under a petrographic microscope and can be extended to include analysis of finer pore sizes by using an electron microscope. These petrographic methods are destructive, time-consuming, and require specialist skills and equipment to acquire the data. Integration of the petrographic data with other estimates of porosity is further complicated as they provide only 2-D images of 3-D characteristics. Despite the accuracy of petrographic analysis the various practical reasons listed above have severely limited its application.

The same recovered samples used for porosity estimates can be used for geological analysis. Geologists require continuous logs of average grain size and grain sorting (equivalent to GSD) to support interpretation of ancient sedimentary environments that, in turn, leads to development of models for the three-dimensional distribution of reservoirs and reservoir characteristics in the subsurface. Knowledge of GSD facilitates integration of geological and physical (wireline logs) data. The current practice of laboratory porosity analysis hinders geological analysis by disrupting and removing samples.

Conventionally, geologists estimate grain size and GSD qualitatively using a hand lens, microscope and an optical comparator. This method is slow and highly subjective but does encourage the close examination of samples. When dealing with sediment, or poorly consolidated sedimentary rock, particle sieving has been widely used. Sieving is time consuming and is limited by its application to naturally loose materials.

Based on work carried out in the nineteenth century, analysis of Fraunhofer diffraction patterns has a long history of success for determining the size of small objects. Automated, quantitative measurement of GSD is also possible using laser diffraction and has been applied to the study of poorly consolidated sandstone reservoirs. Light scattering and laser diffraction both require that samples are disaggregated, which restricts their application to poorly consolidated materials or requires that samples are crushed prior to analysis.

Accordingly, automatic and non-destructive estimation of GSD of porous media is currently impossible.

Characterising the surface distribution of grains and pores is also feasible. For example, a typical instrument for surface characterisation uses a mechanical stylus, or a focussed optical probe, to scan over the surface. Such methods give very detailed information, but are slow, and generate unnecessarily large quantities of data that require excessive processing time.

It can therefore be seen that many of the above techniques require the collection of samples from drill cores, transportation to a laboratory, sample reconstitution, and subsequent sample storage. In addition, they are typically destructive, time consuming and costly with the appropriate resources being unlikely to be available at or near to a wellsite. In particular, at present, there are no quantitative non-destructive methods for grain size analysis despite it being a cornerstone of geological science.

Therefore, despite the high value of the information provided to the industry, the very nature of the prior art techniques profoundly limit the hitherto characterisation of hydrocarbon reservoirs.

In practice, companies predominantly use the wireline method because the sampling density is greater (approximately continuous)and because it does not require that the borehole be cored (which is expensive). Laboratory determination of porosity is primarily used as a cross check to compare and validate the wireline results. However, the nature of the currently available laboratory methods means that samples are relatively widely spaced.

It is an object of the present invention to provide an improved method and device that can be used to rapidly measure porosity and grain size distribution accurately in reservoir core/rock fragments or samples in a continuous and non-destructive manner at the well site during drilling operations.

It is also an object of the present invention to provide a method and device which is non-destructive and portable (preferably hand held) and can rapidly and continuously analyse grain and pore size, and size distribution of porous media (specifically hydrocarbon reservoirs) in hostile and laboratory environments.

According to one aspect of the present invention there is provided a method of ascertaining characteristics relating to porosity and grain size in a rock sample, the method comprising the steps of:
applying light obliquely onto the sample at an angle relative to normal of the surface of the sample;
acquiring light intensity distribution data of the sample as the light is obliquely applied thereto;
processing the acquired light intensity distribution data, to delineate and extract features of significance in the data; and
analysing the processed data to evaluate at least one of said characteristics.

Thus, the use of the present invention enables a decrease in the cost of obtaining the information and makes it possible to collect, with ease, accurate porosity and grain distribution information from throughout the reservoir core rock column. Moreover, the accuracy of reservoir characterisation can be increased and the determination of sub-surface fluid flow dynamics can be improved. This offers the potential to increase the viability of the numerous complex untapped reservoirs and extend the life of many others.

In a preferred embodiment, the step of applying light comprises applying light onto the sample from at least one pair of opposing directions and the step of acquiring light intensity distribution data is effected for each said direction.

In one embodiment, the step of applying light comprises applying light onto the sample from two pairs of perpendicular opposing directions.

In one alternative the processing step finds common points in the light intensity distribution data for the opposing directions and produces a common point distribution based thereon.

In another preferred embodiment, the processing step finds opposing value points in the light intensity distribution data for the opposing directions and produces an edge enhancing distribution based thereon.

In one embodiment, the processing step combines the common point distribution and edge enhancing distribution to evaluate a normalizing distribution.

Preferably, the processing step normalises the light intensity distribution data.

In another preferred embodiment, the processing step applies a thresholding procedure to produce a binarised distribution therefrom.

In one case, the analysing step comprises evaluating the relative amounts of one value or the other that occur in the binarised distribution.

It is preferred that the analysing step comprises using a measuring area to ascertain the amount of one value or the other that occur in the binarised distribution.

In one case, the size of said measuring area can be changed by a predetermined amount and the amount of one value or the other that occur in the binarised distribution is evaluated for each change in measuring area.

In another embodiment, the features of significance in the data comprise descriptors from the acquired image.

In one preferred embodiment, the analysing step comprises evaluating at least one of said characteristics on the basis of features of significance in the data and model data derived from knowledge of the type of sample.

Conveniently, said analysing step comprises the technique of inverse problem solution.

It is also preferred that the processing step comprises noise reduction of the light intensity distribution data.

In one embodiment, said processing step comprises the technique of median filter and wavelet analysis, thresholding and morphological filtering.

In a particular embodiment, said applying light step comprises applying light at an angle of between 30° and 60° relative to normal of the surface of the sample.

Conveniently, said applying light step comprises applying light at an angle of 45° relative to normal of the surface of the sample.

The present invention encompasses a device to ascertain characteristics relating to porosity and grain size in a rock sample, the device operating according to the method as herein above defined.

In a particular embodiment, the method comprises:
light source means locatable to apply light obliquely onto the sample at a angle relative to normal of the surface of the sample;
detector means to acquire an image of the sample as the light is obliquely applied thereto.

Conveniently, said light source means is adjustable to vary the obliquity of the applied light.

In one case, said light source means emits light having one or more selected frequencies.

According to another aspect of the present invention there is provided a device enabling a user to ascertain characteristics relating to porosity and grain size in a rock sample, the device comprising:
light source means locatable to apply light obliquely onto the sample at a angle relative to normal of the surface of the sample;
detector means to acquire an image of the sample as the light is obliquely applied thereto; and
image processing means to extract descriptors from the acquired image and to evaluate at least one of said characteristics on the basis of the extracted descriptors and model data derived from knowledge of the type of sample.

Preferably, said light source means is adjustable to vary the obliquity of the applied light.

In another embodiment, said light source means emits light having one or more selected frequencies.

It is preferred that said image processing means includes low level processing means employing median filter and wavelet analysis, thresholding and morphological filtering.

In another preferred embodiment, said image processing means includes high level processing means employing means for solving inverse problems.

Examples of the present invention will now be described with reference to the accompanying drawings, in which:

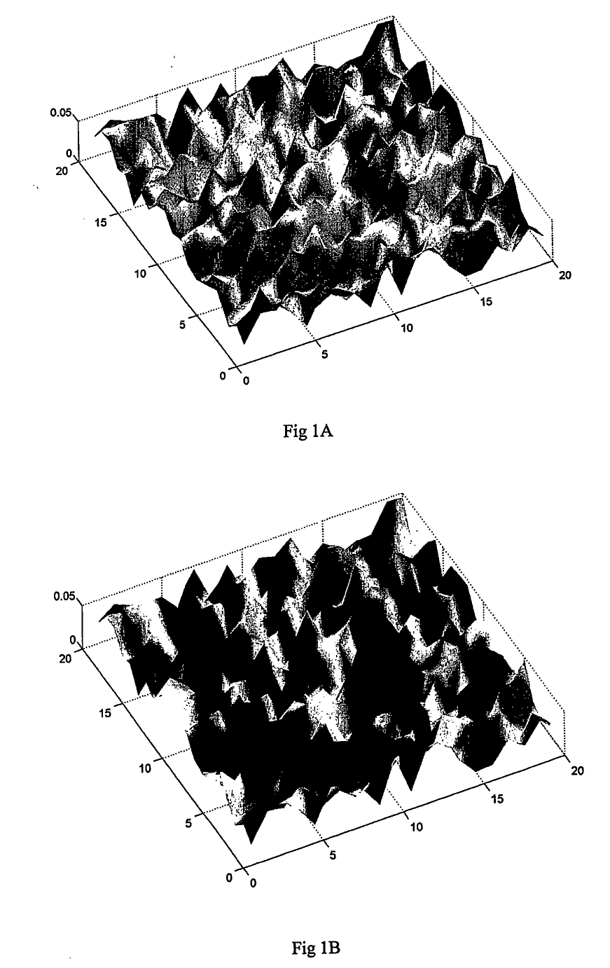

FIG. 1A illustrates a simulated view of a rough surface under near normal illumination

FIG. 1B illustrates a simulated view of a rough surface under oblique illumination;

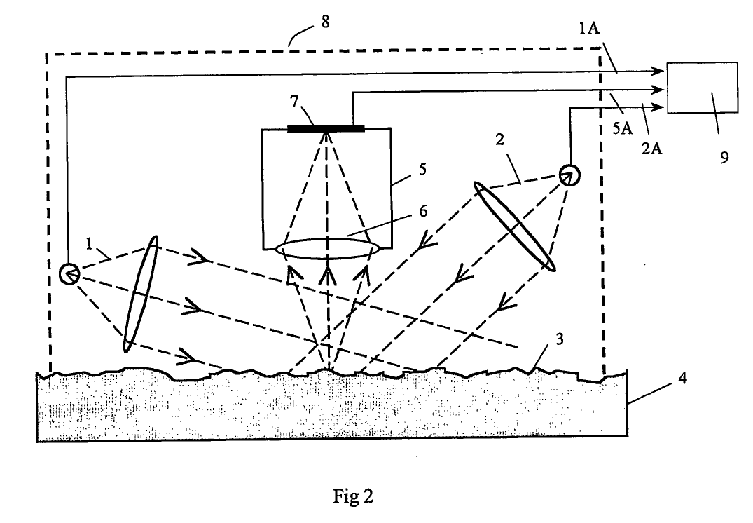

FIG. 2 illustrates in schematic form a device enabling a user to ascertain characteristics relating to porosity and grain size in a rock sample for a first embodiment of the present invention;

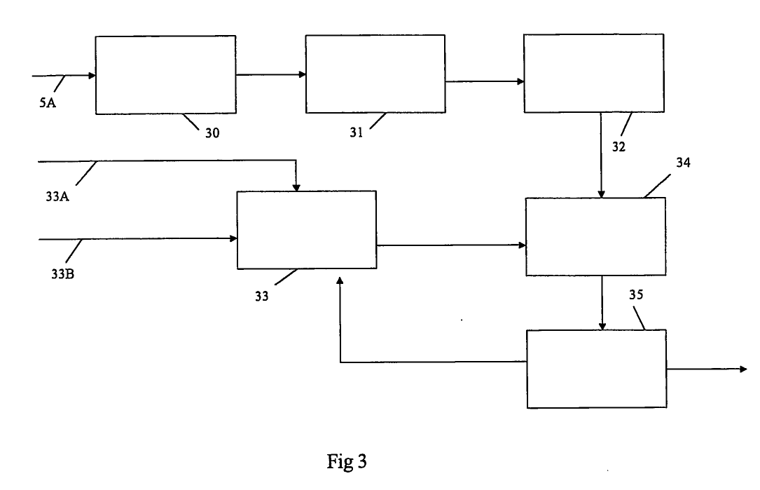

FIG. 3 illustrates a block diagram showing elements of an image processing section used in the device of FIG. 2;

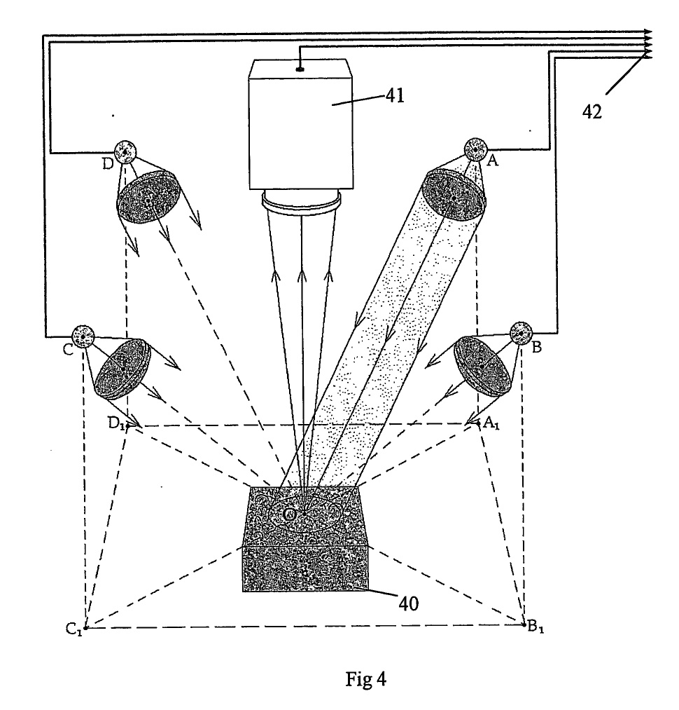

FIG. 4 illustrates in schematic form a device enabling a user to ascertain characteristics relating to porosity and grain size in a rock sample for a second embodiment of the present invention;

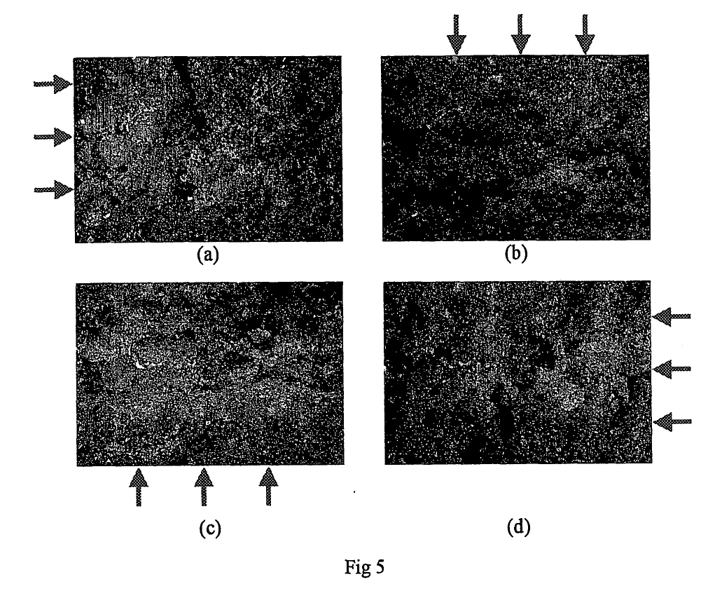

FIG. 5 shows a set of four images of a sample of porous media surface taken with the device shown in FIG. 4;

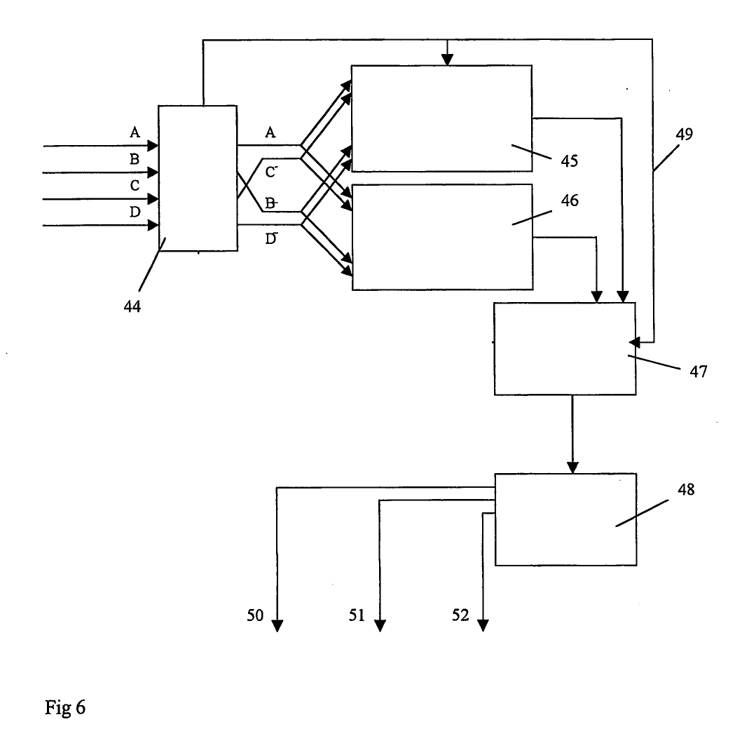

FIG. 6 illustrates a block diagram showing elements of an image processing section used in the device of FIG. 4;

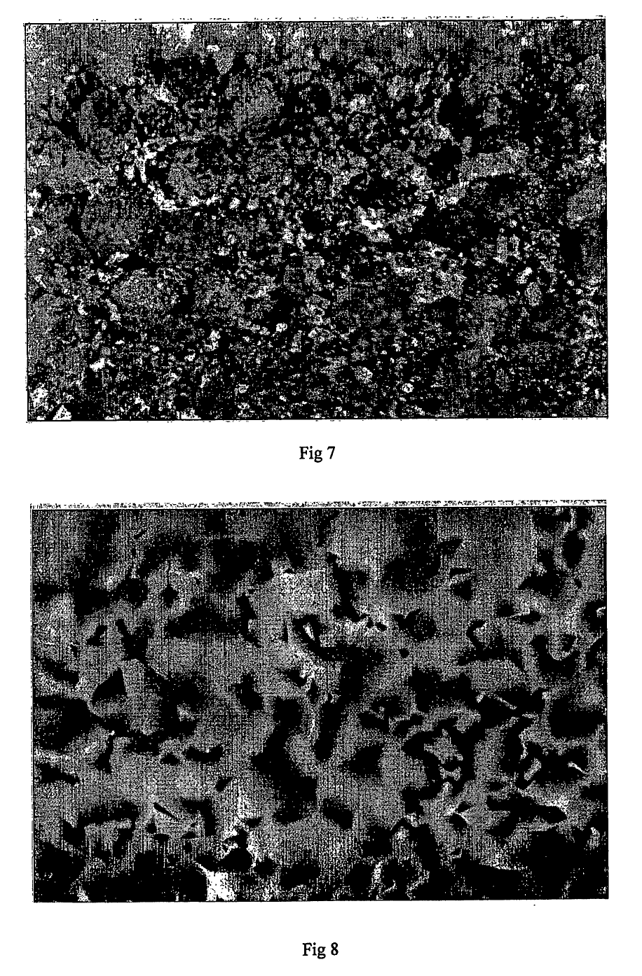

FIG. 7 illustrates the summed intensity distribution of the four filtered images in FIG. 6;

FIG. 8 illustrates a normalising surface calculated in block 45 in FIG. 6;

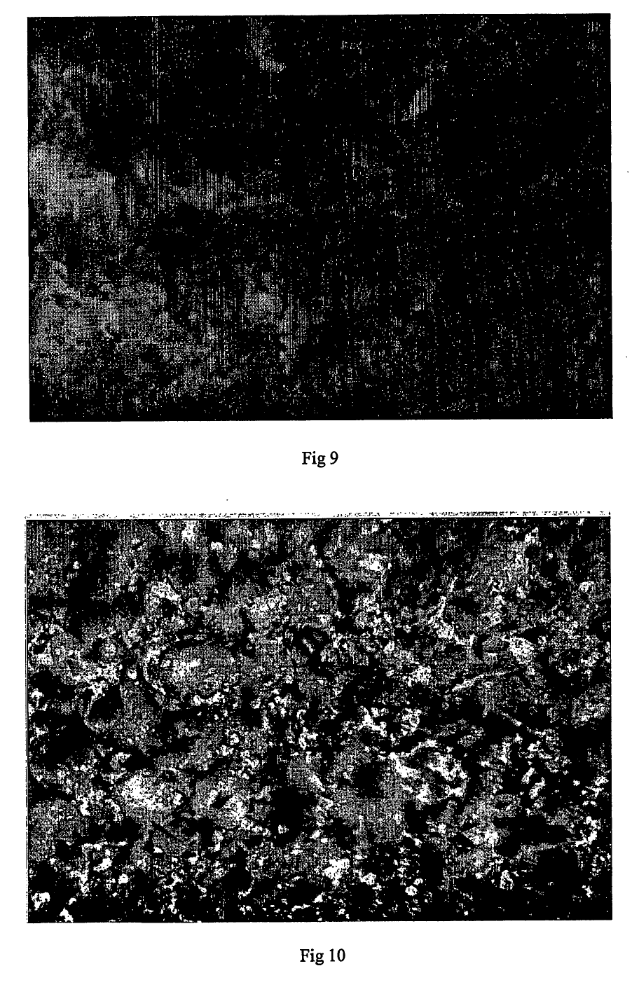

FIG. 9 illustrates an edge enhancing surface calculated in block 46 in FIG. 6;

FIG. 10 illustrates an improved intensity distribution calculated in block 47 in FIG. 6;

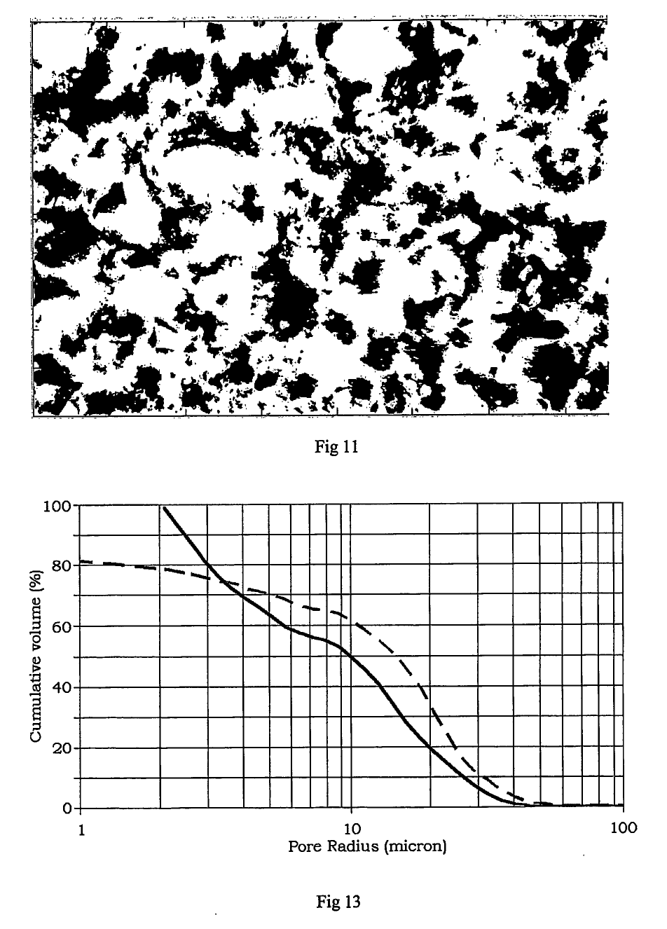

FIG. 11 illustrates a binary image output from block 47 in FIG. 6;

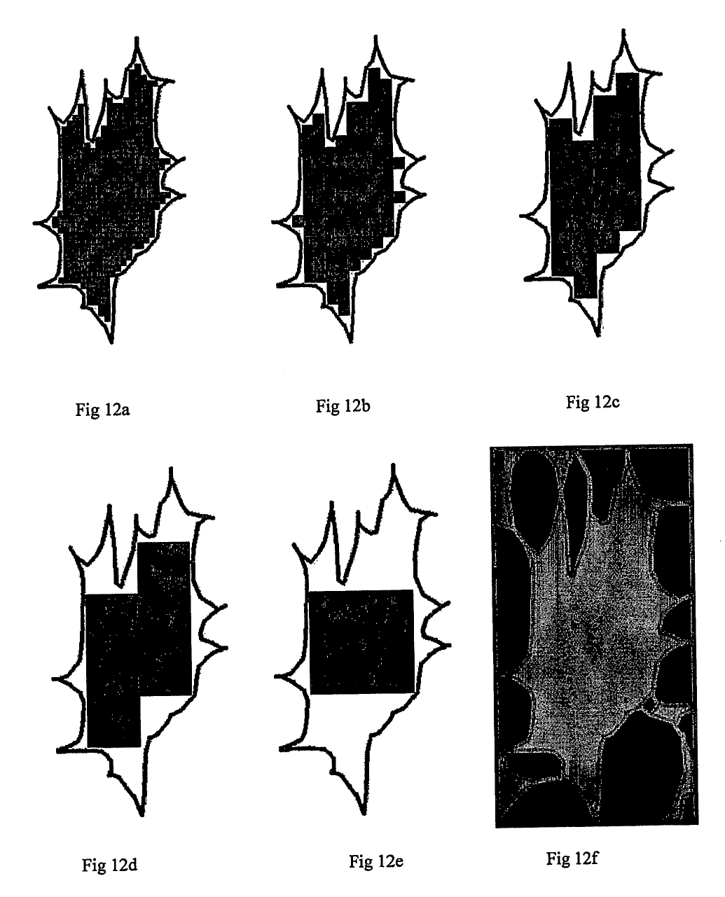

FIGS. 12a to 12f illustrate a process for measuring the volume of areas in the binary image of FIG. 11; and

FIG. 13 shows the dependence of the volume of measured voids versus a size of measuring unit compared with the dependence of cumulative volume of injected mercury versus pore radius obtained from a mercury injection porosimeter for the same sample.

In most cases, the surface of a rock sample will be a flat cut surface and, therefore, an effective cross section through the reservoir rock. Most cores are drilled and then cut in half with a diamond saw. It will be the sawn surface that is analysed. In this context the topographical ‘lows’ will represent the pores within the rock and hence can be used to determine the porosity. These can then be correlated with the independent measurements of observed bulk porosity.

The present invention is based on the idea of directing light obliquely onto the surface of a rock sample at varying angles so that shadows are produced by the grain and pore structure at the sample surface. This will highlight the three dimensional topography of the grains and pores. An image of this shadow structure is then captured. By using varying angles, the digital expression of the image can be analysed in order to identify the three dimensional topography of grains and pores and separate this from surface contrast associated with changes in optical reflectance. From this, the porosity, permeability and GSD can be evaluated.

A first embodiment of the present invention will now be described with reference to FIGS. 1 to 3. Referring to FIG. 2, a first embodiment of a device embodying the present invention has a light source 1, comprising a high intensity continuous red light emitting diode (LED) and collimator for directing incoherent light therefrom in parallel onto a surface 3 of a section of a rock sample 4, and a light source 2, comprising a high intensity continuous green LED and collimator for directing incoherent light therefrom in parallel onto the surface 3 of the section of the rock sample 4. The light source 1 is driven from signals along a line 1A and the light source 2 is driven from signals along a line 2A. Both light sources apply light onto the surface at an angle which is oblique thereto, that is to say it is at an angle to a normal taken through a plane defined by the surface 3 of the rock sample. It will be noted that the light sources apply light at differing angles.

A detector 5 is located between the two light sources. The detector has a macro lens 6 directed at the surface along said normal so as to direct light onto a charge coupled device (CCD)7. Signals from the CCD are relayed along a line 5A to a processing section 9 via digital interfacing (not shown) and an appropriate fast link. The processing section also controls the issuance of signals on lines 1A and 2A. Power for the device is derived from sealed rechargeable cells.

A housing 8 encompasses the two light sources and detector 5 so that external light is prevented from entering the macro lens 6. The device can therefore be self-contained, low-voltage, and can operate in any ambient light conditions.

FIG. 1A shows a simulated view of the light that would be scattered from the surface 3 if the light source directed light along the normal to the surface. However, as can be seen from FIG. 1B, when the light sources 1 and 2 direct light obliquely to the normal, the grains on the surface 3 cast shadows as illustrated. These shadows appear in the image captured by the detector 5.

The processing section 9 controls the reading out of data from the CCD. In addition, the processing section processes the data according to the block diagram of FIG. 3.

The starting point for the processing section is to delineate and extract appropriate descriptors from the images, particularly the shadows. The quality of processing is very important to the information finally delivered. Low level processing is needed to reduce noise and features of low significance. Since the significant features of the shadows are associated with sharp edges, non-linear filtering (median, data-sieve, or wavelet) are particularly applicable. Image segmentation, thresholding and morphological filtering are also employed.

Therefore, initially, in block 30, low and intermediate level image processing is performed on the incoming data to delineate and extract appropriate descriptors from the images, particularly the shadows. In particular, after initial colour separation, low level processing is used to reduce noise and features of low significance because the significant features of the shadows are associated with sharp edges, then median filtering and wavelet analysis are used to enhance signal to noise without degradation of edges.

The enhanced image data is then relayed to block 31 where image segmentation is carried out by thresholding and morphological filtering.

The binarised image data is then subject to object detection and statistical feature extraction in block 32. In this respect, statistical distributions of lengths, areas and spacings are obtained from the shadow images, for varying angles of incident illumination.

Having now obtained the aforementioned statistical distributions, it is necessary to perform image processing and interpretation thereof. The distribution provides detailed and specific information on the surface topography as a result of the shadows. However, this information is still in an indirect form. An inverse problem therefore has to be formulated and solved before results can be presented in terms of grain and pore size distributions, or other derived statistical information. This problem can be specified on the basis of the relationship between rugosity, the shadows and their features. For instance, illumination at near-normal incidence will be effective at delineating pore areas, while illumination at oblique angles will give information on both transverse extent and heights of grains.

Accordingly, the actual statistical distributions of shadow lengths, areas and spacings provide one input to block 34. Another input to block 34 is derived from block 33 which contains parameters of such statistical distributions related to particle (grain) and void (pore) size distributions by semi-empirical models, depending on some prior knowledge of the rock type (or other material) being observed, together with the illumination obliquities. The sample type and illumination obliquities are provided as inputs to block 33 along lines 3A and 33B respectively.

Block 34 together with block 35 then proceeds to set up an inverse problem on the basis of the inputs and to provide an estimate of the grain and pore distributions by solution of the corresponding model equations using, for example, a Levenberg-Marquardt method or other suitable algorithm. A similar method is used to find conventional parameters representing rugosity (surface roughness) if required. As a result of the richness of information in the obliquely illuminated shadow images, these inverse problems have unique solutions. This differs noticeably from other optical methods, for example in optical scattering. Moreover, because the image processing is carried out on-line using statistical representations, it is not necessary to store large volumes of detailed profile data.

The image processing therefore improves image contrast, reduces noise, consolidates regions of similar characteristics through morphological filtering, and segments features in the image. The use of oblique illumination improves the contrast of the images, as well as providing information on the three-dimensional structure of the surface. As a result of the surface rugosity, exact recovery of height profiles has not in general been possible. In this sense, extraction of three dimensional information is indirect, the measured images are matched to a detailed statistical model of the surface.

Thus, surface information can be gathered in a wide selection of cases, and can be successfully interpreted in terms of relevant three dimensional distributions and functional properties.

A second embodiment of the present invention will now be described with reference to FIGS. 4 to 13. Referring to FIG. 4, in this device, there are provided four illuminators A, B, C and D. Each illuminator comprises a high-intensity continuous LED source and a collimator to provide ordinary incoherent illumination. In this embodiment, the centres of the collimated illuminating beams are directed to a point O at the centre of a sample 40. Points A₁, B₁, C₁, and D₁ are projections of the locations of illuminators A, B, C, and D onto the plane of the surface of the sample 40. In this embodiment, the angles ∠AOA₁, ∠BOB_{1, ∠COC}₁, and ∠DOD₁ have the same value of 45°.

A camera 41, comprising a colour digital camera with macro lens, is located directly above the point 0 such that the macro lens thereof is directed at the surface of the sample 40 along a normal thereto. The camera 41, illuminators A and C, and point O of the sample lie in one plane and the camera 41, illuminators B and D, and point O lie in another plane which is perpendicular to the former. The illuminators A, B, C, and D are switched on sequentially in order to acquire four images of the surface of the sample. FIG. 5 shows a set of four images of a sample of porous media surface taken with the device shown in FIG. 4. The illumination side is shown by the arrows.

It should be noted that the angles ∠AOA₁, ∠BOB₁, ∠COC₁, and ∠DOD₁ do not have to be fixed to 45° and can be varied. However, if they are too small, a lot of the details of the surface relief will be lost due to complete shadowing in one or more of the images captured by the camera 41. This feature of complete shadowing defines the lower limit of the possible angles that are effective and will be related to the surface topography of the sample. The rougher the surface is then the higher will be the lower angle limit. The angle should therefore be selected in consideration of the highest anticipated roughness of the samples. For many samples, a lower limit of 30° is preferred.

On the other hand, if the angles ∠AOA₁, ∠BOB₁, ∠COC₁, and ∠DOD₁ are too large there is a decrease in the differences in shade distributions in the four images (in the extreme case of the angle being 90° the images will be identical). This feature of reduced shade distribution defines the upper limit of the possible angles that are effective and will again be related to the surface topography of the sample. The angle should therefore be selected in consideration of the highest anticipated roughness of the samples. For many samples, an upper limit of 60° is preferred. It has been found that values in the range 40° to 50° are effective for sandstone samples and that an angle of 45° is an optimum in this range, representing a compromise between obtaining suitable shade distribution without shadowing effects.

A line 42 connects the illuminators and camera to the acquisition, control, processing and display section. Digital interfacing can be through IEEE1394 “firewire” or other appropriate fast link. It will be appreciated that the device shown in FIG. 4 is within a local “blackout” formed by a flexible skirt (not shown) mounted around the base of the device. The skirt creates a sufficiently dark environment over the area of the sample to allow shadow imaging.

Referring now to the block diagram shown in FIG. 6, block 44 receives the four monochrome images from the camera 41 as each illuminator is individually actuated. Block 44 conducts low level processing to reduce the noise and features of low significance in the four grey scale images from illuminators A, B, C, and D. These filtered images are grouped in two pairs of images with opposite illumination directions (illuminators A and C, B and D) and output to blocks 45 and 46. In addition, the summed intensity distribution of the four filtered images (illuminators A+B+C+D) is calculated in block 44 for further use as one of the inputs in block 45 and 47. An example of such a summed intensity distribution is shown in FIG. 7.

Block 45 therefore receives the paired outputs from block 44. The pore and grain size distributions in the surface of the sample 40 are associated with localisation of grain edges. Considering an individual intensity distribution (for example the distribution in the image resulting from illuminator A), there will be dimmer parts and brighter parts. The brighter part can be considered to be that part of the grain closer to the illuminator since that part of the grain usually slopes towards the illuminator and so appears more intensely illuminated.

The dividing line between the dimmer and brighter parts will be illuminated equally with the light from the opposing illuminators A and C. Such lines can be considered to run along the top or “crest” of each grain, approximately perpendicularly to the plane in which the sample and both illuminators lie (plane OAC in FIG. 4). Thus, block 45 initially proceeds to find the dividing lines using the intensity distribution of the images from illuminators A and C. The same procedure is then independently applied to the other pair of intensity distributions of the images from illuminators B and D to obtain the appropriate lines that are running approximately perpendicularly to the plane in which the sample and the other pair of illuminators lie (plane OBD in FIG. 4). Once again, the dividing lines run along the top or “crest” of each grain.

The common points for both sets of lines are used to define the locations of the tops of every grain whilst the points that correspond to the bottoms of each pore are defined in the same way.

Block 45 then proceeds to obtain a normalizing surface. This is obtained by designating a normalizing value to each point that corresponds to the top of a grain. This value is the inverted value of the intensity in the sum of all four filtered intensity distributions A+B+C+D obtained from the output of block 44. For example, if one of the grain tops has coordinates X and Y and the point with these coordinates in the sum intensity distribution has the intensity I(X,Y), then the normalizing value J(X, Y) of the appropriate point in the normalizing surface is set to be 1/I(X,Y). In the same way, the normalizing value of each point that corresponds to the bottom of a pore is set to 0. It is then possible to build a smooth surface fitting the designated top and bottom points, this is the normalizing surface. Then, the sum intensity distribution is multiplied with the normalizing surface so that the intensity of each grain top Iₙₒᵣₘ(X,Y) will be I(X,Y)*J(X,Y)=1 and the intensity of each pore bottom will be 0.

Thus, block 45 finds the equally illuminated points for the pair of intensity distributions from illuminators A and C, and the intensity distributions from illuminators B and D, considers these points to form lines that divide each grain into two parts, and calculates a normalising surface by means of localisation of the equally illuminated points that correspond to the tops of the grains and to the bottoms of the pores. In effect, it equalises the intensity of all surface grains and the intensity of all surface pores. An example of such a surface is shown in FIG. 8.

Block 46 also receives the paired outputs from block 44. However, in this case areas are found in the pair of intensity distributions from illuminators A and C that are sufficiently differently illuminated (i.e. brightly illuminated in one image and completely shadowed in another). Such areas are considered to correspond to the edges of the grains facing to the respective illuminators (edges that do not face either of these illuminators are not defined in this case). A two dimensional distribution is then formed with maxima at the locations of the defined edges.

This procedure is then repeated with the pair of intensity distributions from illuminators B and D. Thus, the grain edges that face the other pair of illuminators B and D are defined.

The two obtained distributions are then combined to provide an edge enhancing surface which can be used to enhance the intensity of uncertain, partly shadowed sides of the grains. An example of such a surface is shown in FIG. 9.

In block 47, initially, the normalized sum intensity distribution Iₙₒᵣₘ from block 44 is multiplied with the edge enhancing surface from block 45. This produces an improved intensity distribution because the intensity of the grain edges is increased while the intensity of the grains tops and pores bottoms will not be greatly affected. Thus the area of the grains will be more sharply delimited from the area of the pores. An example of such an improved intensity distribution is shown in FIG. 10.

Block 47 then conducts image segmentation by thresholding the improved intensity distribution in order to produce a binary image. This is effected by thresholding the image of FIG. 10 at the level of 0.5, that is to say 50% of its overall intensity variation between grain tops and pore bottoms. Since the edge-enhancing surface has been used, the intensity distribution of that image rapidly changes at the edges of the grains. Thus slight variations of the threshold level near the value 0.5 do not perceptibly affect the resultant binary image. An example of such an image is shown in FIG. 11.

This binary image is then output to block 48. This binary image consists of completely black areas (pores) and completely white areas (grains) (FIG. 12f). Block 48 operates by applying a number N of elementary square cells to the binary image of fixed area. It will be apparent that this measuring area can take different forms. It then proceeds to evaluate if the cell lies in the middle of a white area on the basis that its grey scale level is 256 (completely white). It then proceeds to evaluate if the cell lies in the middle of a black area on the basis that its grey scale level is 1 (completely black). Finally, it proceeds to evaluate if the cell lies at the border between black and white areas and is considered a grey area. For this cell size, block 48 then calculates the relative number of white cells N_{w} classified as in white areas N_{w}/N, the relative number of black cells N_{b} classified as in black areas N_{b}/N, and the relative number of grey cells N_{g} classified as grey areas N_{g}(1)/N

Block 48 then repeatedly increases the size of the elementary cell, and hence reduces the number of such cells for the binary image, and repeats the calculation of the relative number of white cells, the relative number of black cells, and the relative number of grey cells.

According to the resolution of the camera 41, the binary image comprise a certain number of pixels C. In one example, the number of pixels was 512*768.

Therefore, at a first stage (j=1), block 48 sets the elementary square cell to be the size of the camera pixel. Thus, the number of elementary square cells at stage 1 (N(1))=C, the number of pixels C of the camera. Block 48 then finds the relative number of pixels in the black areas N_{b}(1)/N(1) and the relative number of pixels in the white areas N_{w}(1)/N(1). There are no grey pixels in the original binary image (N_{g}(1)/N(1)=0) for stage 1 because the elementary square cell corresponds to the original camera pixel.

Then, at a second stage (j=2), block 48 sets the elementary square cell to be 4 times the number of camera pixels i.e. N(2)=N(1)/4=C/4. In effect, block 48 transforms the size of the original binary image (but using a grey scale format) to reduce the number of elementary square cells. Thus, in this second stage, each elementary square cell of the transformed image has 4 original pixels of the original image. The level of grey scale intensity assigned to each cell at stage 2 is the mean value of the original pixels that it contains. If a stage 2 pixel lies in the middle of the white area it will contain four white stage 1 pixels and its grey scale level will be 256 (completely white). If a stage 2 pixel lies in the middle of a black area its grey scale level will be 1 (completely black). Those stage 2 pixels that lie at the border between black and white areas will contain both white and black original pixels (1 white and 3 black or 2 white and 2 black or 3 white and 1 black). Such stage 2 pixels will be grey (grey levels 64, 128, and 192 respectively).

Block 48 then finds the relative number of white cells classified as in white areas N_{w}(2)/N(2), the relative number of black cells classified as in black areas N_{b}(2)/N(2), and the relative number of grey cells classified as in grey areas N_{g}(2)/N(2) for the stage 2 elementary square cell.

Then, at a third stage (j=3), block 48 transforms the size of the original binary image to N(3)=N(2)/4=N(1)/16=C/16 and again obtains the relative numbers of cells classified as in black areas N_{b}(3)/N(3), the relative numbers of cells in the white areas N_{w}(3)/N(3), and the relative numbers of cells in the grey areas N_{g}(3)/N(3) pixels.

As the size of the elementary square cell is increased (the number of camera pixels in a cell increases) and hence the number of cells within the original image is gradually decreased, the relative number of cells classified as in white, black and grey areas is calculated. At the j-th stage the cell area is N(n)=N(1)/4ⁿ⁻¹). It has been found that the last calculation is based on 6 cells. At that stage, there are usually neither black nor white cells and all of them are grey: N_{b}(j)/N(j)=0, N_{w}(j)/N(1)=0 and N_{g}(j)/N(1)=1.

As the size of the cells at a stage becomes larger relative to the original camera pixel, the overall amount of black and white areas within the image both become smaller because the areas of the pores and grains are not completely filled with elementary square cells. This effect is illustrated in FIG. 12. It will be apparent that instead of increasing the size of the elementary cell, the process can decrease the size of the elementary cell.

It is possible to draw the dependence of an area of a black (or white) area versus the ‘radius’ of pore (or grain, respectively) obtained as a diagonal of an elementary square cell. In FIG. 13, the solid curve shows an example of such a void area dependence graph (obtained from images of a real sandstone sample). This figure shows the dependence of the volume of measured voids (black fields in FIG. 11) versus a size of measuring unit compared with the dependence of cumulative volume of injected mercury versus pore radius obtained from a mercury injection porosimeter for the same sample. In order to give such a distribution better spatial resolution, the change in cell size at each stage, in terms of camera pixel numbers, can be changed more gradually (say by a factor m where m<4) so that N(n)=N(1)/mⁿ⁻¹.

The area dependence graphs are closely related to cumulative area distributions for grains or pores. They take into account the fine structure of the boundaries of larger pores or grains. In this respect, such graphs closely mimic the cumulative volume distributions obtained from mercury porosimetry, where the size (capillary pressure) axis indicates the smallest feature size included in the corresponding measured mercury (pore) volume. Grain size distribution, pore size distribution, and porosity can be easily obtained from the calculated curves (e.g. size distributions are the increments of the appropriate curves at each interval of pore or grain radii) and provided as outputs from block 48 for appropriate usage (e.g on a display). In the present embodiment, output 50 representing pore size distribution, output 51 representing grain size distribution and output 52 representing porosity.

With this embodiment, there is excellent correlation between the output of block 48 and the output of a mercury porosimeter and the output gives data of direct value for petrophysical analysis. The information obtained optically is from 2-dimensional (or ‘near 2-dimensional’) rock surfaces, while true grain and pore distributions are inherently 3-dimensional. In addition, the level of correlation between optical and Mercury data depends to some extent on rock type. Thus, using the blocks 33, 34 and 35 of the first embodiment can refine the estimates of size distribution in such cases.

It should be noted that four illuminators are used in this embodiment. The reason for this is because the locally horizontal regions (the peaks and troughs of the rough surface) produce equally bright points in each of the pairs of images obtained with oppositely directed illumination from the illuminators. This provides a method of identifying topographic features (namely the peaks and troughs) that is robust, being largely independent of other sources of surface contrast. This facilitates the use of the normalization process of the image brightness, in which all the peaks and troughs are set to the same high and low intensity levels, respectively. This in turn greatly assists the identification of the grain and pore outlines by the thresholding process.

It is preferred that the number of illuminators is an even number because the pairs of images with opposite illumination are used in this method. The use of just one pair of images will be inferior because there are areas on the sides of grains which have the same or not sufficiently different illumination intensity. This would make it extremely difficult to determine the edges of the grains in those areas. Thus, four illuminators and accordingly four images is an optimum number although it will be apparent that alternatives with six, eight, etc. illuminators could be used. Whilst increasing the number of illuminators may yield very slight increases of accuracy, they significantly increase the time of calculation by 1½, 2 and so on times accordingly.

It will be appreciated that elaborate optical arrangements are not required. In addition, the features captured for analysis, the shadows themselves, are automatically on a length scale similar to the surface topography of interest.

The device is operated by an on/off switch followed by a single button to acquire, store and process the images. A digital read out (not shown) displays estimates of average porosity and grain size. The image processing is carried out using standard embedded microcontroller hardware.

The device of the present invention can therefore provide non-destructive analysis of particle (grain) and void (pore) size distribution, and estimates of average particle size and void space. This device is also non-destructive in comparison to current laboratory methods. Moreover, as a result of the simplicity of the device, it can be hand-held and fully self-contained, including an internal low voltage power source. It is also possible to obtain porosity readings at a high frequency (continuous) and they can be obtained both horizontally and vertically of a bore sample. Taking numerous readings horizontally will not only provide a more accurate average porosity value (rocks are not homogeneous) at a particular depth, but will also provide valuable information about the small scale lateral variation of porosity. Taking numerous readings vertically will enable the data to be more directly compared with the wireline data and could therefore be used as a more effective comparison and calibration tool. In addition, these readings can be taken at much smaller intervals than in the wireline logging process which takes readings with a vertical spacing of the order of tens of centimetres. Thus, the present invention has the potential for providing a more detailed picture of the vertical distribution of porosity within a reservoir than is currently available.

It will be appreciated that the digital images that are acquired, analysed and stored, can be transferred to independent computing equipment via a USB or other link.

In another embodiment of the invention, the light sources are provided to enable variation of their obliquity of illumination, in order to obtain sufficiently rich data. This can be achieved either by using arrays of light sources, or through chromatic coding, or both. Whilst the device described operates with ordinary incoherent illumination, usually provided by high-intensity continuous LED sources, different light sources can provide flexibility of application. The particular angles of illumination are set to cover the range of surface slopes on the samples of interest. By using the shadows in the captured image, the features captured for analysis (the shadows themselves) are automatically on a length scale similar to the surface topography of interest. By using varying angles of illumination, and optionally colour-coding, improved separation of information about grain sizes and heights from pore sizes is possible.

It will be appreciated that with the device of the present invention, it is not necessary to acquire large amounts of data and is equally applicable to sediment or rock. In addition, in certain circumstances it can be expected that during the sawing process, a certain number of grains will be plucked from the rock. This would have the potential for artificially increasing the resultant porosity if a hole left from a plucked grain is wrongly interpreted as a pore space. It is expected that the image processing of the present invention will enable differentiation between these two situations, as the shape of the void resulting from a pore or plucked grain will be very different in each case. For example, most sandstone reservoirs where this is likely to be a problem can be approximated to a packing of spherical grains. In this context the surface of a pore space can be expected to consist of strongly convex slopes but the surface of a void created by removing a grain will consist of concave slopes.

Table 1 below illustrates a comparison between the present invention and prior art methods of porosity and pore size distribution measurement.

TABLE 1

| | | Core | Petrog- | Fluid | Present |
|---|---|---|---|---|---|
| | Wireline | Plugs | raphy | Injection | invention |
| Destructive | No | Yes | Yes | Yes | No |
| In situ | Yes | No | No | No | No |
| Cost | Low | Moderate | Moderate | High | Low |
| Speed | Fast | Slow | Slow | Slow | Fast |
| Frequency | High | Moderate | Low | Low | High |
| Robust | Yes | Variable | Variable | Yes | Yes |
| Skill Factor | Low | Moderate | High | High | Low |

Table 2 below illustrates a comparison between the present invention and prior art methods of grain size distribution measurement.

TABLE 2

| | Compa- | | | | Present |
|---|---|---|---|---|---|
| | rator | Sieving | Diffraction | Stylus | invention |
| Destructive | No | Yes | Yes | No | No |
| Cost | Low | Moderate | High | High | Low |
| Speed | Slow | Slow | Slow | Slow | Fast |
| Frequency | Variable | Low | Low | High | High |
| Robust | Variable | High | High | High | High |
| Skill Factor | Moderate | Moderate | High | High | Low |

By way of explanation, in these tables, in situ refers to where the method is applied in the subsurface. Frequency refers to the sampling density along a 1-D profile. Robust reflects whether the method is prone to inaccuracy if materials or the operational environment are compromised. Skill factor is a measure of the level of specialist skills required by an operator to provide an estimate of porosity.

1-34. (canceled)

35. A method of ascertaining characteristics relating to porosity and grain size in a rock sample or the like, the method comprising the steps of:
providing multiple light sources to respectively apply light obliquely onto a surface of the sample at an angle relative to the normal thereof;
capturing an image of the surface of the sample for each respective light source, the image comprising a light intensity distribution data sample;
processing a combination of the light intensity distribution data samples of different captured images to produce from the combination a distribution showing features of significance amongst the data samples;
analysing the distribution to evaluate at least one of said characteristics.

36. A method according to claim 35 wherein said distribution comprises a common point distribution produced by finding common points amongst light intensity distribution data samples of the images.

37. A method according to claim 35 wherein said distribution comprises an edge enhancing distribution based on opposing value points amongst the light intensity distribution data samples of the images.

38. A method according to claim 35 wherein said distribution comprises a common point distribution produced by finding common points amongst light intensity distribution data samples of the images and said distribution comprises an edge enhancing distribution based on opposing value points amongst the light intensity distribution data samples of the images, and said processing further comprises combining said common point distribution and said edge enhancing distribution.

39. A method according to claim 36 wherein said processing includes normalising the distribution.

40. A method according to claim 39 wherein the processing applies a thresholding procedure to the normalised distribution to produce a binarised distribution therefrom.

41. A method according to claim 40 wherein the analysing step comprises evaluating the relative amounts of one value or the other that occur in the binarised distribution.

42. A method according to claim 41 wherein the analysing step comprises using a measuring area to ascertain the amount of one value or the other that occur in the binarised distribution.

43. A method according to claim 42 wherein the size of said measuring area can be changed by a predetermined amount and the amount of one value or the other that occur in the binarised distribution is evaluated for each change in measuring area.

44. A method according to claim 35 wherein the analysing step comprises evaluating at least one of said characteristics on the basis of features of significance in the distribution and model data derived from knowledge of the type of sample.

45. A method according to claim 44 wherein said analysing step comprises the technique of inverse problem solution.

46. A method according to claim 35 wherein the processing includes noise reduction of the light intensity distribution data sample.

47. A method according to claim 35 wherein said multiple light sources apply light at an angle of between 300 and 600 relative to normal of the surface of the sample.

48. A method according to claim 47 wherein said multiple light sources apply light at an angle of 45° relative to normal of the surface of the sample.

49. A method according to claim 35 wherein at least one pair of multiple light source are provided, the light sources of a pair applying light in opposing directions.

50. A method according to claim 47 wherein at least first and second pairs of multiple light source are provided, the light sources of the first pair applying light perpendicular to the light sources of the second pair.

51. A porous media characteristic measuring device capable of ascertaining characteristics relating to porosity and grain size in a porous media, the device comprising:
a plurality of light sources to respectively apply light obliquely onto a surface of the sample at an angle relative to the normal thereof;
image capturing means to capture an image of the surface of the sample for each respective light source, the image comprising a light intensity distribution data sample;
processing means to process a combination of the light intensity distribution data samples of different captured images to produce from the combination a distribution showing features of significance amongst the data samples;
analysing means capable of analysing the distribution to evaluate at least one of the characteristics relating to porosity and grain size.

52. A device according to claim 51 wherein the processing means finds points of light intensity value that are common to different light intensity distribution data samples to produce a common point distribution.

53. A device according to claim 52 wherein the processing means finds points of light intensity value that are common to light intensity distribution data samples captured from images from opposing light sources.

54. A device according to claim 51 wherein the processing means finds intensity value points from opposing light intensity distribution data samples of the images to produce an edge enhancing distribution.

55. A device according to claim 51 wherein the processing means produces said distribution as a common point distribution produced by finding common points amongst light intensity distribution data samples of the images and said processing means produces said distribution as an edge enhancing distribution based on opposing value points amongst the light intensity distribution data samples of the images, and wherein said processing means combines said common point distribution and said edge enhancing distribution.

56. A device according to claim 55 wherein said processing means normalises the distribution.

57. A device according to claim 56 wherein the processing means applies a thresholding procedure to the normalised distribution to produce a binarised distribution therefrom.

58. A device according to claim 57 wherein the analysing means evaluates the relative amounts of one value or the other that occur in the binarised distribution.

59. A device according to claim 58 wherein the analysing means uses a measuring area to ascertain the amount of one value or the other that occur in the binarised distribution.

60. A device according to claim 59 wherein the size of said measuring area can be changed by a predetermined amount and the amount of one value or the other that occur in the binarised distribution is evaluated for each change in measuring area.

61. A device according to claim 51 wherein the analysing means comprises evaluates at least one of said characteristics on the basis of features of significance in the distribution and model data derived from knowledge of the type of sample.

62. A device according to claim 61 wherein said analysing means uses the technique of inverse problem solution.

63. A device according to claim 51 wherein the processing means noise reduction of the light intensity distribution data sample.

64. A device according to claim 51 wherein said plurality of light sources apply light at an angle of between 30° and 60° relative to normal of the surface of the sample.

65. A device according to claim 64 wherein said plurality of light sources apply light at an angle of 45° relative to normal of the surface of the sample.

66. A device according to claim 51 wherein at least one pair of light sources are provided, the light sources of a pair applying light in opposing directions.

67. A device according to claim 66 wherein at least first and second pairs of light sources are provided, the light sources of the first pair applying light perpendicular to the light sources of the second pair.

68. A device according to claim 51 wherein said plurality of light sources emit light having one or more selected frequencies.

69. A method of analysing a binarised distribution, the method comprising the steps of:
using a measuring area to ascertain the amount of one value or the other that occur in the binarised distribution;
changing the size of said measuring area by a predetermined amount and evaluating for each change in measuring area the amount of one value or the other that occur in the binarised distribution.
